(19) United States
(12) Patent Application Publication
(10) Pub. No.: US 2026/0340889 A1
(43) Pub. Date: Oct. 29, 2026

(54) RENDERING COLORS ON SURFACES

(71) Applicant: Walmart Apollo, LLC, Bentonville, AR (US)

(72) Inventors: Daniel Hyunwoo Lee, Whittier, CA (US); Sreeneel Maddika, San Ramon, CA (US); Anoop Pratap Singh Tomar, Fremont, CA (US); Vijay Saradhi Yellapragada, San Ramon, CA (US)

(73) Assignee: Walmart Apollo, LLC, Bentonville, AR (US)

(21) Appl. No.: 19/191,577

(22) Filed: Apr. 28, 2025

(51) Int. Cl. G06T 11/10; G06T 5/92; G06V 10/28

(52) U.S. Cl. CPC G06T 11/10; G06T 5/92; G06V 10/28

(57) ABSTRACT

Example implementations may relate to systems and methods for rendering colors on surfaces while preserving lighting. For example, a computer-implemented method may include receiving an input image. The computer implemented method can also include receiving a binary mask comprising a region of interest. The computer implemented method can further include generating a greyscale image of the input image. The computer-implemented method can additionally include determining a mean pixel value for a region of interest of the greyscale image, wherein the region of interest of the greyscale image is equivalent to the region of interest of the binary mask. The computer-implemented method can also include generating a gamma corrected image of the greyscale image based on the mean pixel value for the region of interest of the greyscale image. The computer-implemented method can further include combining a color with the gamma-corrected image, comprising multiplying the color with the gamma-corrected image to form a color-mask image. The computer-implemented method can additionally include overlaying the color-mask image onto the input image to generate an output image. Other embodiments are described.

### FIELD OF THE DISCLOSURE

The present disclosure generally relates to rendering colors on surfaces while preserving lighting.

### BACKGROUND

Object surfaces may exhibit various colors. Accurate color visualization can make colors appear vibrant and true under various lighting scenarios and may play a role in consumer decisions.

### BRIEF DESCRIPTION OF THE DRAWINGS

The figures described below depict various aspects of the systems, methods, and non-transitory computer readable storage media disclosed therein. It should be understood that each figure depicts an embodiment of a particular aspect of the disclosed systems, methods, and non-transitory computer readable storage media, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a block diagram for rendering colors on surfaces while preserving lighting, according to one embodiment;

FIG. 2 illustrates a flowchart for a method of rendering colors on surfaces while preserving lighting, according to one embodiment;

FIG. 3A illustrates an input image;

FIG. 3B illustrates a binary mask comprising a region of interest of the input image (FIG. 3A.), according to one embodiment;

FIG. 4 illustrates a front elevation view of two computer systems and a mobile device that are suitable for implementing an embodiment of the system disclosed in FIG. 1; and

FIG. 5 illustrates a representative block diagram of an example of the elements included in the circuit boards inside a chassis of the computer systems of FIG. 4.

The figures depict embodiments for purposes of illustration only. One skilled in the art will readily recognize from the following discussion that other embodiments of the systems, methods, and non-transitory computer-readable media storing computing instructions that are described herein can be employed without departing from the principles of the technology described herein.

### DETAILED DESCRIPTION

The present embodiments can generally relate to rendering colors onto surfaces, various embodiments can include a computer implemented method including receiving an input image. The computer implemented method can also include receiving a binary mask comprising a region of interest. The computer implemented method can further include generating a greyscale image of the input image. The computer-implemented method can additionally include determining a mean pixel value for a region of interest of the greyscale image, wherein the region of interest of the greyscale image is equivalent to the region of interest of the binary mask. The computer-implemented method can also include generating a gamma corrected image of the greyscale image based on the mean pixel value for the region of interest of the greyscale image. The computer-implemented method can further include combining a color with the gamma-corrected image, comprising multiplying the color with the gamma-corrected image to form a color-mask image. The computer-implemented method can additionally include overlaying the color-mask image onto the input image to generate an output image.

In other embodiments, a system can be provided. The system can include one or more local or remote processors or servers, mobile devices, smart glasses including augmented reality glasses, virtual reality headsets, mixed or extended reality headsets, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more certain operations. The operations can include receiving an input image. The operations can also include receiving a binary mask comprising a region of interest. The operations can further include generating a greyscale image of the input image. The operations can additionally include determining a mean pixel value for a region of interest of the greyscale image, wherein the region of interest of the greyscale image is equivalent to the region of interest of the binary mask. The operations can also include generating a gamma corrected image of the greyscale image based on the mean pixel value for the region of interest of the greyscale image. The operations can further include combining a color with the gamma-corrected image, comprising multiplying the color with the gamma-corrected image to form a color-mask image. The operations can additionally include overlaying the color-mask image onto the input image to generate an output image

Other embodiments can include a non-transitory computer-readable medium storing computing instructions that, when executed on a processor, cause the processor to perform certain operations. The operations can include receiving an input image. The operations can also include receiving a binary mask comprising a region of interest. The operations can further include generating a greyscale image of the input image. The operations can additionally include determining a mean pixel value for a region of interest of the greyscale image, wherein the region of interest of the greyscale image is equivalent to the region of interest of the binary mask. The operations can also include generating a gamma corrected image of the greyscale image based on the mean pixel value for the region of interest of the greyscale image. The operations can further include combining a color with the gamma-corrected image, comprising multiplying the color with the gamma-corrected image to form a color-mask image. The operations can additionally include overlaying the color-mask image onto the input image to generate an output image.

Rendering colors onto a select surface of an image can be a challenging problem that involves color theory and preservation of lighting, shadows, and textures to realistically depict how colors would look in a certain space. Some approaches overlay a color on top of the select surface of the image with color blending techniques such as color dodging, burning, lighting, etc., resulting in unrealistic and inaccurate paint color renderings. This approach offers technical improvements that can generate accurate color visualizations on the select surface, taking into consideration the shadow and/or lighting levels for each pixel on the surface of a region of interest.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

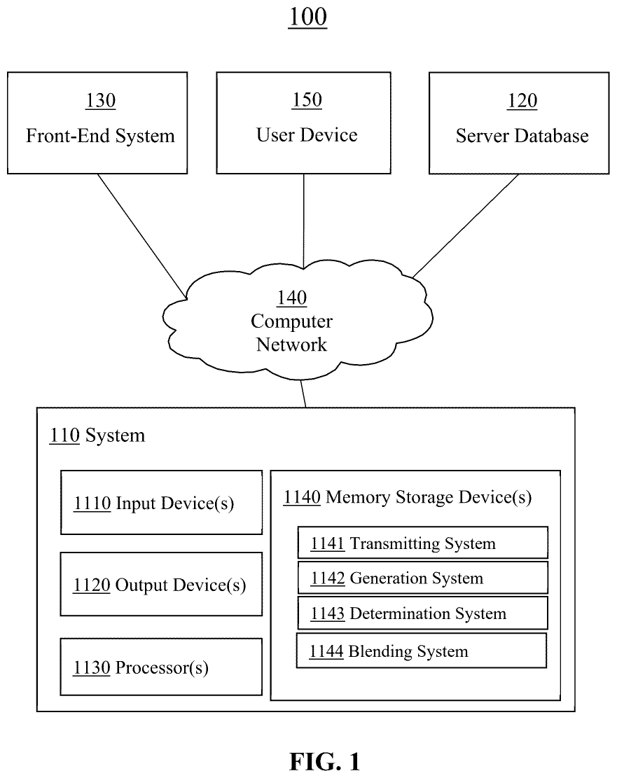

Turning to the drawings, FIG. 1 illustrates a block diagram of a system 100 for rendering colors on surfaces while preserving lighting, according to various embodiments. System 100 is an example, and embodiments of the system are not limited to the embodiments presented herein. The system can be employed in many different embodiments or examples not specifically depicted or described herein. In some embodiments, certain elements, modules, or systems of system 100 can perform various procedures, processes, operations, actions, and/or activities. In other embodiments, the procedures, processes, operations, actions, and/or activities can be performed by other suitable elements, modules, or systems of system 100. Generally, system 100 can be implemented with hardware and/or software, as described herein.

In some embodiments, system 100 can include a server database 120 and a system 110. In the same or different embodiments, system 100 also can include a front-end system 130, a computer network 140, and a user device 150.

In some embodiments, system 110, server database 120, front-end system 130, and/or user device 150 can include systems which can include computing instructions stored on non-transitory computer readable media and executable by one or more processors or can, in addition or as an alternative, include a hardware device comprising electronic circuitry for implementing the functionality described below. For example, system 110 can include memory storage devices 1140 which can include a transmitting system 1141, a generation system 1142, a determination system 1143, and/or a blending system 1144, as described further herein below. In other embodiments, system 110, server database 120, front-end system 130, and/or user device 150 can be implemented in hardware, including ASICs (application specific integrated circuits) and the like.

In some embodiments, system 110 can comprise one or more systems, subsystems, modules, models, or servers. The one or more systems, subsystems, modules, models, or servers can be implemented, at least in part, in software and/or firmware stored in or loaded on an internal or remote memory storage device(s) of system 110 and executed on a processor of system 110. In various embodiments, one or more of system 110, front-end system 130, user device 150, and server database 120 can include one or more of trained machine learning (ML) and/or artificial intelligence (AI) models (the ML/AI models). System 110, front-end system 130, user device 150, and/or server database 120 can be a component used to implement a portion of the system, method, and/or non-transitory computer-readable medium, as described herein. Additional details regarding system 110, front-end system 130, user device 150, and server database 120 are described herein.

In some embodiments, system 110, server database 120, front-end system 130, and/or user device 150 can be in data communication, through a computer network, a telephone network, or the Internet (e.g., computer network 140) with each other. In other embodiments, system 110, server database 120, front-end system 130, and user device 150 are in direct communication with each other using, for example, Bluetooth communication.

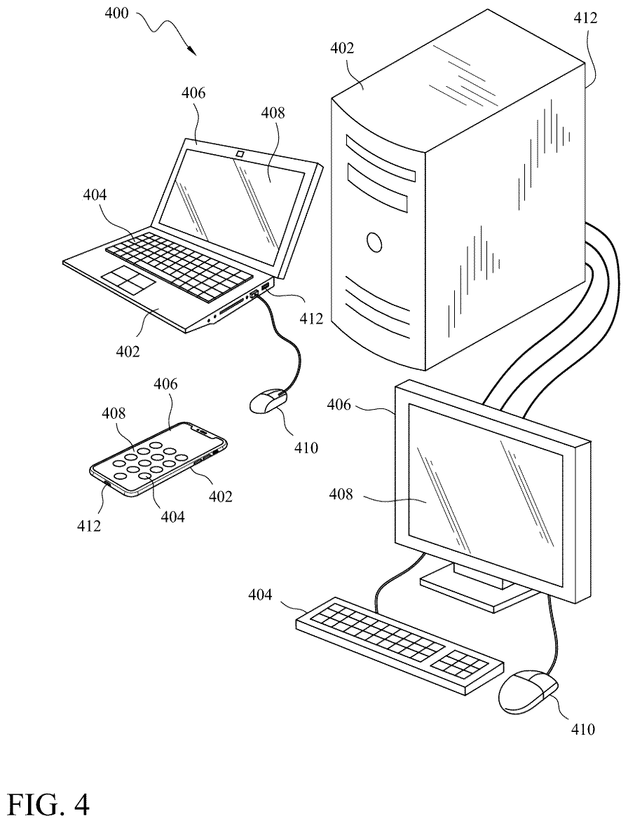

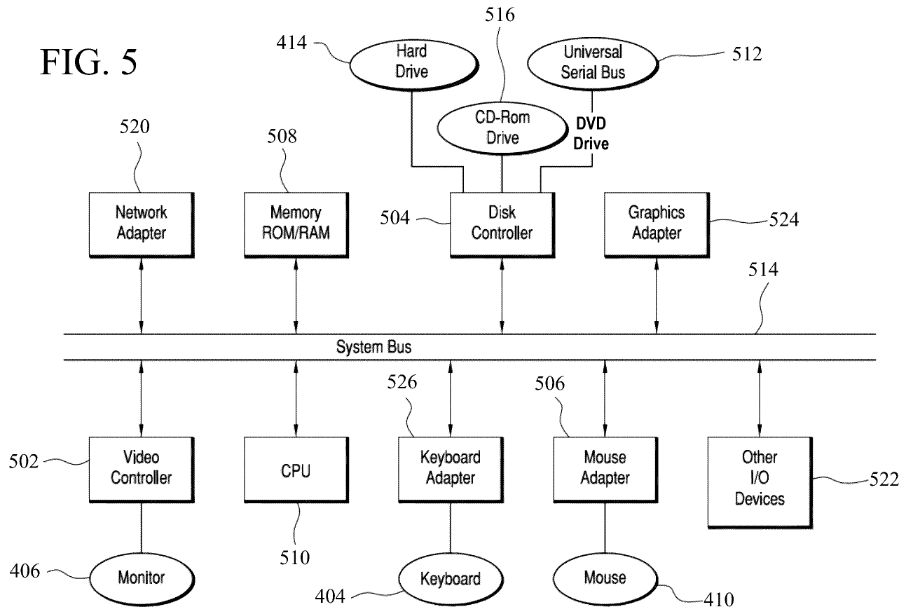

In some embodiments, system 110, server database 120, front-end system 130, and/or user device 150 can include one or more input devices, one or more output devices, one or more processors, and/or one or more memory storage devices. For example, system 110 can include input devices 1110, output devices 1120, processors 1130, and/or memory storage devices 1140. Examples of input devices can include one or more keyboards, one or more keypads, one or more pointing devices such as a computer mouse or computer mice, one or more touchscreen displays, a microphone, a camera, keyboard 404 (FIG. 4), mouse 410 (FIG. 4), etc. Examples of output devices can include one or more monitors, one or more touch screen displays, projectors, monitor 406 (FIG. 4), screen 408 (FIG. 4), etc. Other examples of output devices can include other I/O device 522 (FIG. 5), network adapter 520, wireless transmitters, wired transmitters, and the like. Examples of processors can include CPU 510 (FIG. 5), etc. Examples of memory storage devices can include memory storage unit 508 (FIG. 5), external storage units coupled to input/output port 412 (FIGS. 4-5), hard drive 414 (FIG. 5), CD-ROM and/or DVD drive 516 (FIG. 5), a detachable drive coupled to input/output port 412 (FIGS. 4-5), etc. In a number of embodiments, input devices further can include one or more cameras and/or one or more microphones. In the same or different embodiments, input devices can include one or more GPS (Global Positioning System) sensor(s), one or more accelerometers, and/or one or more gyroscopes.

Input devices and output devices can be coupled to their respective component (e.g., system 110, server database 120, front-end system 130, and/or user device 150) in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple an input device and an output device to a processor and/or a memory storage device, all of a particular user device. In a similar manner, the processors and/or memory storage devices of the user devices can be local and/or remote to each other.

In certain embodiments, user device 150 can be one or more mobile devices, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, other smart jewelry, augmented-reality (AR) headsets, virtual-reality (VR) headsets, etc.), or another portable computer device with the capability to present audio and/or visual data (e.g., images, videos, music, etc.).

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, or (iv) a Galaxy™ Tab or Smartphone or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

The one or more databases can be stored on one or more memory storage units (e.g., non-transitory computer readable media), which can be similar or identical to the one or more memory storage units (e.g., non-transitory computer readable media) described above with respect to computer system 400 (FIG. 4). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communications between one or more of system 110, server database 120, front-end system 130, and user device 150 can be implemented using any suitable manner of wired and/or wireless communication. Accordingly, system 110, server database 120, front-end system 130, and user device 150 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc. ; LAN and/or WAN protocol(s) can include Institute of Electrical and Electronic Engineers (IEEE) 802.3 (also known as Ethernet), IEEE 802.11 (also known as WiFi), etc. ; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

In some embodiments, system 110 can be configured to transmit to a user device 150 of a user, or to a graphical user interface (e.g., a webpage, a graphical user interface of a mobile application, etc.) for display on the user device. System 110, server database 120, front-end system 130, and/or user device 150 can determine, by using any suitable approaches or ML/AI models, the statistics, notices, augmented reality views, feedback, and other information. Algorithms for the ML/AI models for determining the information can include decision trees, K Nearest Neighbor (KNN), neural networks, CatBoost, support vector machine, etc.

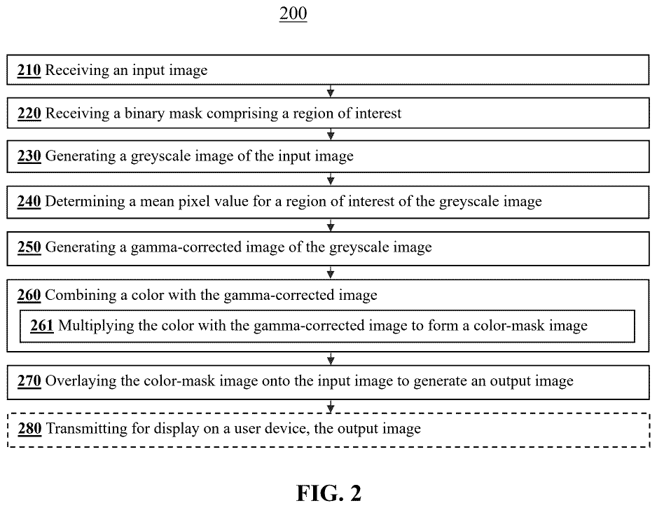

Turning ahead in the drawings, FIG. 2 illustrates a flow chart for a method 200 for rendering colors on surfaces while preserving lighting, according to one embodiment. Method 200 can be implemented via execution of computing instructions configured to run on one or more processors and stored on one or more non-transitory computer-readable media, and/or via one or more ASICs. Method 200 is merely an example and is not limited to the embodiments presented herein. Method 200 can be employed in many different embodiments or examples not specifically depicted or described herein.

In some embodiments, the procedures, the processes, the operations, the actions, and/or the activities of method 200 can be performed in the order presented. In other embodiments, the procedures, the processes, the operations, the actions, and/or the activities of method 200 can be performed in any suitable order. In still other embodiments, one or more of the procedures, the processes, the operations, the actions, and/or the activities of method 200 can be combined together or skipped.

In some embodiments, system 110 (FIG. 1) can be suitable to perform method 200 and/or one or more of the operations, actions, and/or activities of method 200. In these or other embodiments, one or more of the operations, actions, and/or activities of method 200 can be implemented as one or more computing instructions configured to run on one or more processors and configured to be stored on one or more non-transitory computer readable media, and/or as one or more ASICs. Such non-transitory computer readable media can be part of a computer system such as system 110, server database 120, front-end system 130, and/or user device 150. The processor(s) can be similar or identical to the processor(s) described below with respect to computer system 400 (FIG. 4).

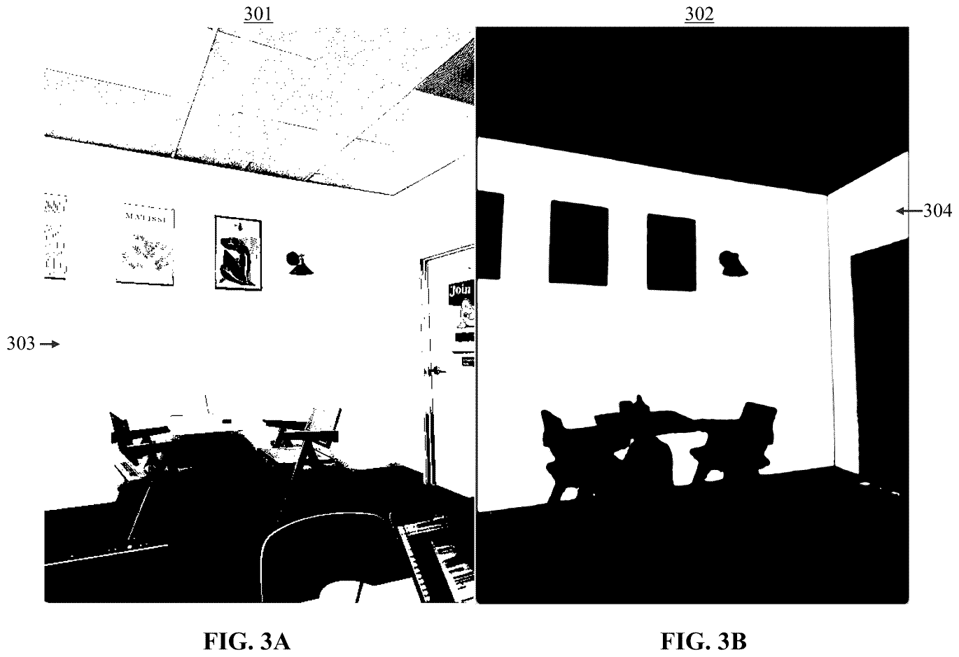

Referring to FIG. 2, in some embodiments, method 200 can include a block 210 of receiving an input image. For example, image 301 (FIG. 3A) can be received as the input image. The input image can be received from the memory or storage unit of user device 150 (FIG. 1), an imaging device of user device 150 (FIG. 1) (e.g., camera, webcam, etc.), cloud storage, or computer network 140 (FIG. 1). The camera can be a front facing or rear facing camera of user device 150 (FIG. 1). The input image can be a still image or a video and be received in any format (e.g., JPEG, PNG, TIFF, BMP, SVG, WebP, HEIC, etc., for still images, MP4, MOV, AVI, WMV, MKV, FLV, WebM, HEVC, etc. for videos., or GIF for animations) The input image can be received in a compressed or uncompressed format. The input image can also be a passthrough image from the camera of user device 150 (FIG. 1). The passthrough image from the camera of user device 150 (FIG. 1) can be in real-time or near real-time.

Continuing with FIG. 2, in some embodiments, method 200 also can include a block 220 of receiving a binary mask comprising a region of interest. For example, binary mask 302 (FIG. 3B) can be received. Binary mask 302 can comprise a region of interest 302 (FIG. 3B) of wall 303 (FIG. 3A). The binary mask can be received from a machine learning model. The AI model can comprise a Grounding DINO and/or a Segment Anything Model (SAM). The region of interest of the binary mask can comprise a surface. The surface can be derived from any material, with any shape, curvature, color and light level. For example, the surface can be a building finish such as a wall (e.g., drywall, wood paneling, brick, concrete, tiles, glass, plaster, stone, metal panels, fabric, plasterboard, stucco, adobe, PVC panels, wallpaper, etc.) or floor (e.g., tile, carpet, hardwood, laminate, vinyl, bamboo, cork, etc.), and/or clothes. The surface can also be a furnishing (e.g., a dining table, as countertop, a couch, a nightstand, a lounge chair, a curtain, etc.). The surface can further be a part of a person's body (e.g., eyelashes, skin, eyes, etc.).

Continuing with FIG. 2, in some embodiments, method 200 additionally can include a block 230 of generating a greyscale image of the input image. The input image can be converted to a greyscale image ranging from 0.0 to 1.0 pixel value.

Continuing with FIG. 2, in some embodiments, method 200 further can include a block 240 of determining a mean pixel value for a region of interest of the greyscale image. Determining the mean pixel value can comprise counting only pixels in the region of interest of the binary mask. For example, the region of interest can be pixels where a wall is detected. The region of interest of the greyscale image can be equivalent to the region of interest of the binary mask.

Continuing with FIG. 2, in some embodiments, method 200 additionally can include a block 250 of generating a gamma-corrected image of the greyscale image. The gamma-corrected image of the greyscale image can be generated based on the mean pixel value for the region of interest of the greyscale image, as determined in block 240. The gamma-correct image can be generated using a logarithmic function in any programming language. For example, using iOS swift, the gammaFilter.power function can be used. Example code in iOS Swift can be:

gammaFilter.power=log(Target)/log(imageMean)

Example Code in Python/OpenCV can be:

image_mean=cv2.mean(image, mask)

gamma=math.log(Target*255)/math.log(image_mean[0])

image=np.power(image, gamma).clip(0,255).astype(np.uint8)

Target can refer to value representative of a target brightness in some languages/codes or a target darkness/shadow, depending on the language and function. The value of Target can differ depending on the surface. For example, Target can be a different value when the surface is a wall, compared to when the surface is part of a person's body. The value of Target can also differ depending on the brightness of the surface. For example, Target can be a higher value when the surface is darker surface and a lower value when the surface is a brighter surface.

Continuing with FIG. 2, in some embodiments, method 200 further can include a block 260 of combining a color with the gamma-corrected image. Combining the color with the gamma-corrected image can comprise a block 261 of multiplying the color with the gamma-corrected image to form a color-mask image. For example, the RGB (red, green, and blue) values of the color can be multiplied by the corresponding RBG values of the gamma-corrected image to generate the color-mask image. The color can be picked by the user or be a preset color.

Continuing with FIG. 2, in some embodiments, method 200 further can include a block 270 of overlaying the color-mask image onto the input image to generate an output image. The color-mask image can be overlayed onto the input image such that the region of interests overlaps, so that only the region of interest of the input image is modified to generate the output image.

Continuing with FIG. 2, in some embodiments, method 200 further can include a block 280 of transmitting for display on a user device, the output image. The output image can be a still image or a video and be received in any format (e.g., JPEG, PNG, TIFF, BMP, SVG, WebP, HEIC, etc., for still images, MP4, MOV, AVI, WMV, MKV, FLV, WebM, HEVC, etc. for videos, or GIF for animations). The input image can be received in a compressed or uncompressed format. The input image can also be a passthrough image from the camera of user device 150 (FIG. 1). By virtue of the gamma-corrected image preserving information about lighting variations, shadows, textures, and the like, the color-mask image also preserves such information and the generated output image can have an accurate and realistic appearance. For example, the output image may be useful in providing a realistic depiction of paint colors on the surface of a wall. The wall can be textured or untextured (e.g., drywall, stucco, adobe, brick, plank, etc.). The paint can be textured or untextured and reflective or flat. Further, the output image may be useful in providing a realistic depiction of cosmetic products on a person's body. In some examples, a realistic depiction of applied lipstick, blush, and/or concealer can be applied on a person's face. In other examples, a realistic depiction of colored contact lenses can be applied on a person's eyes. In yet other examples, a realistic depiction of nail polish, hair dye, and highlights for the hair can be applied for a person in the output image.

Turning ahead in the drawings, FIG. 4 illustrates an embodiment of three different types (e.g., a laptop, a tower server, and a mobile device) of a computer system 400, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 400 (and its internal components, or one or more elements of computer system 400) can be suitable for implementing part, or all of, the techniques described herein. Computer system 400 can comprise chassis 402 containing one or more circuit boards (not shown) and one or more of an input/output port 412 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

A representative block diagram of the elements included on the circuit boards inside chassis 402 is shown in FIG. 5. A central processing unit (CPU) 510 in FIG. 5 is coupled to a system bus 514. In various embodiments, the architecture of CPU 510 can be compliant with any of a variety of commercially distributed architecture families.

Continuing with FIG. 5, system bus 514 can also be coupled to memory storage unit 508 that includes both read only memory (ROM) and random access memory (RAM). Non-volatile portions of memory storage unit 508 or the ROM can be encoded with a boot code sequence suitable for restoring computer system 400 (FIG. 4) to a functional state after a system reset. In addition, memory storage unit 508 can include microcode such as a Basic Input-Output System (BIOS). In some examples, the one or more memory storage units of the various embodiments disclosed herein can include memory storage unit 508, a USB-equipped electronic device (e.g., an external memory storage unit (not shown) coupled to input/output port 412 (FIGS. 4-5)), hard drive 414 (FIG. 4), and/or one or more CD-ROM, DVD, Blu-Ray, or other suitable media, such as media configured to be used in a CD-ROM and/or DVD drive 416 (FIG. 4) inside chassis 402 (FIG. 4) or in a detachable drive coupled to input/output port 412.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 510.

In the depicted embodiment of FIG. 5, various I/O (input/output) devices such as a disk controller 504, a graphics adapter 524, a video controller 502, a keyboard adapter 526, a mouse adapter 506, a network adapter 520, and other I/O devices 522 can be coupled to system bus 514. Keyboard adapter 526 and mouse adapter 506 can be coupled to a keyboard 404 (FIGS. 4-5) and a mouse 410 (FIGS. 4-5), respectively, of computer system 400 (FIG. 4). While graphics adapter 524 and video controller 502 are indicated as distinct units in FIG. 5, video controller 502 can be integrated into graphics adapter 524, or vice versa in other embodiments. Video controller 502 is suitable for refreshing a monitor 406 (FIGS. 4-5) to display images on a screen 408 (FIG. 4) of computer system 400 (FIG. 4). Disk controller 504 can control hard drive 414 (FIG. 5), input/output port 412 (FIGS. 4-5), and CD-ROM and/or DVD drive 516 (FIG. 5). In other embodiments, distinct units can be used to control each of these devices separately.

In some embodiments, network adapter 520 can comprise and/or be implemented as a WNIC (wireless network interface controller) card (not shown) plugged or coupled to an expansion port (not shown) in computer system 400 (FIG. 4). In other embodiments, the WNIC card can be a wireless network card built into computer system 400 (FIG. 4). A wireless network adapter can be built into computer system 400 by having wireless communication capabilities integrated into the motherboard chipset (not shown), and/or implemented via one or more dedicated wireless communication chips (not shown), connected through a PCI (peripheral component interconnector) or a PCI express bus of computer system 400 (FIG. 4) or input/output port 412 (FIG. 4). In other embodiments, network adapter 420 can comprise and/or be implemented as a wired network interface controller card (not shown).

Although many other components of computer system 400 are not shown, such components and their interconnection are well-known to those of ordinary skill in the art. Accordingly, further details concerning the construction and composition of computer system 400 and the circuit boards inside chassis 402 are not discussed herein.

When computer system 400 in FIG. 4 is running, program instructions stored on a USB drive in input/output port 412, on a CD-ROM or DVD in CD-ROM and/or DVD drive 516 (FIG. 5) or in the detachable CD-ROM and/or DVD drive coupled to input/output port 412, on hard drive 414 (FIG. 5), or in memory storage unit 508 (FIG. 5) are executed by CPU 510 (FIG. 5). A portion of the program instructions, stored on these devices, can be suitable for carrying out all or at least part of the techniques described herein. In various embodiments, computer system 400 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 400, and can be executed by CPU 510. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 400 is illustrated as a laptop computer, a tower server, or a mobile device in FIG. 4, there can be examples where computer system 400 can take a different form factor while still having functional elements similar to those described for computer system 400. In some embodiments, computer system 400 can comprise a single computer, a single server, or a cluster or collection of computers or servers, or a cloud of computers or servers. Typically, a cluster or collection of servers can be used when the demand on computer system 400 exceeds the reasonable capability of a single server or computer. In certain embodiments, computer system 400 can comprise a portable computer, such as a laptop computer. In certain other embodiments, computer system 400 can comprise a mobile device, such as a smartphone, smart glasses, a virtual reality headset, augmented reality glasses, etc. In certain additional embodiments, computer system 400 can comprise an embedded system.

For each of the machine learning models to be retrained, the respective training datasets can be updated manually by a system user (e.g., an ML engineer, a data scientist, etc.) and/or automatically by a system (e.g., system 110 (FIG. 1)). The system user can select new training data from various data sources. The system can collect new training data based upon various criteria. In certain embodiments, historical input and/or output data of the model to be re-trained can be used for re-training the model. In several embodiments, the historical input and/or output data of the model can be selected based upon system performance and/or user feedback from the system user associated with the historical output data. In various embodiments, when more than one training dataset is used for the pretraining and/or retraining, the system (e.g., system 110 (FIG. 1)) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pretrain or retrain the one or more machine learning models. The system can predetermine the common hierarchy, structure, schema, etc. As needed, the system can reformat the data from various training dataset into a common data format so that the data can be used properly and efficiently by the system.

In some embodiments, the machine learning models, AI algorithms, classifiers, etc. can be customized and/or fine-tuned for the user. For example, the customized classifiers can be stored locally on system 110 (FIG. 1). As another example, one or more of these customized classifiers can be trained and/or retrained remotely and stored locally (e.g., at system 110 (FIG. 1)).

Examples of the algorithms used for the various ML/AI models for one or more of the above-mentioned procedures, processes, activities, actions, operations, and/or methods can include BERT (Bidirectional Encoder Representations from Transformers), LLM (Language Learning Models), Lambda, Palm, XLNet, GPT-3 (generative pretraining transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In some embodiments, the systems and/or methods can be configured to train or re-train the one or more ML/AI models. The training of each of the ML/AI models can be supervised, semi-supervised, and/or unsupervised-which in some embodiments can be followed by, or used in conjunction with, other techniques, such as re-enforcement machine learning techniques, or other techniques utilized by ChatGPT-based voice bots or virtual assistants. The training data of training datasets for pretraining or retraining each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In some embodiments, the trained and/or re-trained ML/AI model as well as the training datasets can be stored in, updated, and accessed from a database. In the same or different embodiments, when more than one training dataset is used for the pretraining and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pretrain or retrain the one or more machine learning models. In some embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback and/or predetermined criteria. The user feedback can be associated with the output data of the ML/AI models or the output of the systems and/or methods using the ML/AI models.

Relating FIG. 2 to FIG. 1, as an example, transmitting system 1141 (FIG. 1) can perform block 210, 220, and 280; generation system 1142 (FIG. 1) can perform blocks 230, 250, and 270; determination system 1143 (FIG. 1) can perform block 240; and/or blending system 1144 (FIG. 1) can perform block 260. User device 150 (FIG. 1) can include the same systems as system 110 (FIG. 1).

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pretrained ML/AI model, without any re-training.

Although systems and methods for rendering colors on surfaces while preserving lighting have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-5 can be modified, and that the foregoing discussion of certain of these embodiments does not necessarily represent a complete description of all possible embodiments. Additionally, one or more of the procedures, processes, operations, actions, and/or activities of the method in FIG. 2 can include different procedures, processes, actions, and/or activities and be performed by many different modules, in many different orders. As an example, the modules, models, elements, and/or systems within system 100 in FIG. 1 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” may be interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a server computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
a processor; and
a non-transitory computer-readable medium storing instructions that, when executed on the processor, cause the processor to perform operations comprising:
receiving an input image;
receiving a binary mask comprising a region of interest;
generating a greyscale image of the input image;
determining a mean pixel value for a region of interest of the greyscale image, wherein the region of interest of the greyscale image is equivalent to the region of interest of the binary mask;
generating a gamma-corrected image of the greyscale image based on the mean pixel value for the region of interest of the greyscale image;
combining a color with the gamma-corrected image, comprising multiplying the color with the gamma-corrected image to form a color-mask image; and
overlaying the color-mask image onto the input image to generate an output image.

2. The system of claim 1, wherein generating the gamma-corrected image comprises using a logarithmic function.

3. The system of claim 1, wherein the binary mask is received from a machine learning model.

4. The system of claim 1, wherein the region of interest of the binary mask comprises a surface.

5. The system of claim 4, wherein the surface comprises at least one of a building finish, a furnishing, or a part of a person's body.

6. The system of claim 1, wherein the input image comprises a passthrough image.

7. The system of claim 1, wherein the input image comprises a video.

8. A computer-implemented method comprising:
receiving an input image;
receiving a binary mask comprising a region of interest;
generating a greyscale image of the input image;
determining a mean pixel value for a region of interest of the greyscale image, wherein the region of interest of the greyscale image is equivalent to the region of interest of the binary mask;
generating a gamma-corrected image of the greyscale image based on the mean pixel value for the region of interest of the greyscale image;
combining a color with the gamma-corrected image, comprising multiplying the color with the gamma-corrected image to form a color-mask image; and
overlaying the color-mask image onto the input image to generate an output image.

9. The computer-implemented method of claim 8, wherein generating the gamma-corrected image comprises using a logarithmic function.

10. The computer-implemented method of claim 8, wherein the binary mask is received from a machine learning model.

11. The computer-implemented method of claim 8, wherein the region of interest of the binary mask comprises a surface.

12. The computer-implemented method of claim 11, wherein the surface comprises at least one of a building finish, a furnishing, or a part of a person's body.

13. The computer-implemented method of claim 8, wherein the input image comprises a passthrough image.

14. The computer-implemented method of claim 8, wherein the input image comprises a video.

15. A non-transitory computer-readable medium storing computing instructions that, when executed on a processor, cause the processor to perform operations comprising:
receiving an input image;
receiving a binary mask comprising a region of interest;
generating a greyscale image of the input image;
determining a mean pixel value for a region of interest of the greyscale image, wherein the region of interest of the greyscale image is equivalent to the region of interest of the binary mask;
generating a gamma-corrected image of the greyscale image based on the mean pixel value for the region of interest of the greyscale image;
combining a color with the gamma-corrected image, comprising multiplying the color with the gamma-corrected image to form a color-mask image; and
overlaying the color-mask image onto the input image to generate an output image.

16. The non-transitory computer-readable medium of claim 15, wherein generating the gamma-corrected image comprises using a logarithmic function.

17. The non-transitory computer-readable medium of claim 15, wherein the region of interest of the binary mask comprises a surface.

18. The non-transitory computer-readable medium of claim 17, wherein the surface comprises at least one of a building finish, a furnishing, or a part of a person's body.

19. The non-transitory computer-readable medium of claim 15, wherein the input image comprises a passthrough image.

20. The non-transitory computer-readable medium of claim 15, wherein the input image comprises a video.
